(19) United States
(12) Patent Application Publication
(10) Pub. No.: US 2026/0192599 A1
(43) Pub. Date: Jul. 9, 2026

(54) CASTER WITH A RUNNING WHEEL HAVING AN AXIS OF ROTATION AND A RUNNING SURFACE

(71) Applicant: TENTE GmbH & Co. KG, Wermelskirchen (DE)

(72) Inventors: Karl-Heinz PLAUTZ, Hagen (DE); Peter GERHARD, Leverkusen (DE); Michael BLOCK, Wermelskirchen (DE)

(73) Assignee: TENTE GmbH & Co. KG, Wermelskirchen (DE)

(21) Appl. No.: 18/864,056

(22) PCT Filed: Jun. 20, 2023
(86) PCT No.: PCT/EP2023/066552

§ 371 Date: Nov. 8, 2024

(30) Foreign Application Priority Data
Jun. 23, 2022 (DE) 10 2022 115 678.8

(51) Int. Cl. B60B 33/00

(52) U.S. Cl. CPC B60B 33/0081; B60B 33/0049

(57) ABSTRACT

A caster has a running wheel with a running surface and a locking element with a locking jaw that is movable between a release position and an engagement position in which the locking jaw acts on the running surface to lock the running wheel. In the engagement position, the locking jaw is movable from an initial blocking position into a final blocking position due to a rotational movement of the running wheel. The locking element has an elongated support surface for the locking jaw and the locking jaw has a supporting surface which interacts with the support surface. The supporting surface is movable along the support surface during a movement from the initial blocking position into the final blocking position, so that the supporting surface is offset in the circumferential direction in the final blocking position with respect to the support surface and to its initial position.

### FIELD OF TECHNOLOGY

The invention relates to a caster, in particular a steering caster, with a running wheel having an axis of rotation and a running surface, wherein a locking element with a locking jaw is provided and the locking element is movable between a release position and an engagement position in which the locking jaw engages on the running surface to lock the running wheel, wherein furthermore, in the engagement position, the locking jaw, while supported on the locking element, is movable from an initial blocking position into a final blocking position due to a rotational movement of the running wheel itself, wherein in addition, the locking jaw is designed as wedge-shaped in a cross section in which the axis of rotation is represented as a point, and the locking element has a support surface for the locking jaw and the locking jaw has a supporting surface that interacts with the support surface.

The invention further relates to a caster, in particular a steering caster, with a running wheel having an axis of rotation and a running surface, wherein a locking element with a locking jaw is provided and the locking element is movable between a release position and an engagement position in which the locking jaw engages on the running surface to lock the running wheel, wherein furthermore, the locking element is designed as a first lever part of a toggle lever arrangement and is connected to a second lever part of the toggle lever arrangement in a toggle joint, wherein in addition, an end effector moves the locking jaw into the engagement position by moving the toggle lever arrangement out of a first, more strongly angled position into a second, less angled position.

### PRIOR ART

Casters of the type in question are known, particularly in an embodiment as a steering caster. The caster has a running wheel which is preferably rotatably mounted in a fork. In the case of a steering caster, the running wheel is pivotable about a vertical axis. The fork may, for example, have a mounting pin, by means of which an arrangement of the caster on a frame may be achieved. The running wheel may be rotationally blocked with respect to a geometric running wheel axis of rotation via the locking jaw of the locking element, for which purpose it may be brought into an engagement position that interacts with the running surface of the running wheel. A wedge-shaped effect of the locking jaw between the locking element and the running surface of the running wheel may thereby arise. In this regard, reference is made, for example, to EP 3 572 239 A1 (U.S. Pat. No. 10,857,833 B2 and also to EP 0 364 732 A1. Casters are known from DE 39 08 313 U1 as well as from DE 79 24 594 U1, in which the locking jaw is movable from the release position into the engagement position via a toggle lever arrangement.

With regard to the prior art described above, the present invention is concerned with the object of further designing a caster of the type in question in an advantageous way, particularly with regard to the effect of the locking jaw on the running wheel, more particularly on the running surface of the running wheel.

According to a first inventive idea, a possible solution to the problem is provided in a caster, in which it is intended that the support surface is designed to be elongated in a circumferential direction of the running wheel, and that the supporting surface is movable along the support surface in the circumferential direction during a movement out of the initial blocking position into the final blocking position, so that the supporting surface as a whole is offset in the circumferential direction in the final blocking position with respect to the support surface and with respect to its position in the initial blocking position.

This advantageously results in an elongated support surface which extends oriented substantially along the running surface curvature. The support surface does not necessarily assume the curved course of the running surface and therefore does not necessarily extend concentrically with the running surface. The support surface may extend straight in its longitudinal extent, however, it is preferably curved. The support surface may also have a curvature in its longitudinal extent that differs from the curvature of the running surface. The curvature of the support surface—with respect to the immediately opposite curvature areas of the support surface and the running surface—may be selected to be opposite to the curvature of the running surface. Merely due to the selected arrangement and design of the support surface of the locking element, this may advantageously result in a wedge-like configuration of the area between the locking element and the running surface to be filled by the locking jaw.

In the previously described cross section, in the case of a curved course, as is also preferred, of the support surface, a geometric center may result, as is more preferred, to which a resulting line of curvature of the support surface, extending in the longitudinal extension of a circular line at least partially corresponding to a circular line, relates, which geometric center is outside of the locking element, if necessary, outside of the caster as a whole. The support jaw is further preferably displaceable in the circumferential direction of the running wheel about this geometric axis.

An extension dimension of the support surface in the circumferential direction of the running surface may result, which may correspond to, for example, approximately two or three one-hundredths of the circumferential length of the running surface, thus further corresponding, for example, to at least one one-hundredth up to four one-hundredths or more, further corresponding up to, for example, five one-hundredths or one-tenth of the circumferential length of the running surface.

For example, the extension dimension may furthermore be approximately two or three to 5 mm or more, for example up to 7 mm or more.

The supporting surface of the locking jaw may move across this extension dimension along the support surface of the locking element, or the locking jaw may shift relative to the locking element out of the initial blocking position into the final blocking position and vice versa.

In the final blocking position, the supporting surface of the locking jaw is thereby displaced with respect to the support surface of the locking element in comparison to the arrangement in the initial blocking position along the alignment of the support surface. The degree of displacement may thereby correspond at a maximum to the extension dimension of the supporting surface.

In another embodiment, both the support surface and also the supporting surface may correspondingly be provided, if necessary multiple times, when viewed in the circumferential direction of the running surface; furthermore, this is the case, for example, at a relatively small extension of a few millimeters (for example up to 4 or 5 mm) of a support surface, when viewed in the circumferential direction.

It may also be provided that the dimension of the supporting surface of the locking jaw, when viewed in the circumferential direction of the running surface of the running wheel, is less than or equal to the extension dimension of the support surface of the locking element.

The problem may also be solved by a further inventive idea in a caster with a locking element as part of a toggle lever arrangement, in that the second position may only be maintained under constant application of force by the end effector.

There advantageously results from this the possibility of a preferably automatic return of the toggle lever arrangement and thus of the locking jaw from the second position in the direction toward the first position as soon as the application of force by the end effector is suspended. Correspondingly, there is no stable self-latching of the toggle lever arrangement without a sustained application of force. Preferably, no active, rearward displacement of the toggle lever elements, nor also the locking jaw, takes place, for example, due to being entrained in the direction toward the initial position preferably defined by the first position.

To suspend the locking or engagement position of the locking jaw, the proposed embodiment only requires the suspension of the application of force on the toggle lever arrangement, by which means a simplified structure of the caster as a whole is further achieved in an advantageous way.

The features of the previously described independent claims are important both in themselves and also in any combination with one another, wherein further features of one independent claim are combinable with the features of a further independent claim or with the features of several independent claims, furthermore, also with only individual features of one or more of the further independent claims.

For example, there may be a caster in which the support surface is designed to be elongated in a circumferential direction of the running wheel, wherein the supporting surface is movable along the support surface in the circumferential direction during a movement out of the initial blocking position into the final blocking position, so that the supporting surface as a whole is displaced in the circumferential direction in the final blocking position with respect to the support surface and with respect to its position in the initial blocking position, and wherein furthermore, the locking element is designed as a first lever part of a toggle lever arrangement and is connected to a second lever part of the toggle lever arrangement in a toggle joint, wherein in addition, an end effector moves the locking jaw into the engagement position by moving the toggle lever arrangement out of a first, more strongly angled position into a second, less angled position, and wherein the second position may only be maintained under constant application of force by the end effector.

Further features of the invention are subsequently explained, also in the description of the figures, often in their preferred assignment to the subject matter of claim 1 and/or of the further independent claim or to features of further claims. However, they may also be of significance in an assignment to only individual features of claim 1 and/or of the further independent claim or of the respective further claim or respectively independently.

According to one possible further refinement, the locking element may have a holding opening, which is elongated in the circumferential direction of the running wheel, for the locking jaw. The holding opening may thereby be designed in the shape of a slot, wherein furthermore, a flank delimiting this slot may simultaneously form the support surface. Correspondingly, there may further preferably result a longitudinal extension of the slot-like holding opening as a whole in the direction of extension of the support surface.

The holding opening may, as is also preferred, simultaneously offer a path restriction with respect to the displaceability of the locking jaw relative to the locking element.

The locking jaw itself may be designed to be double wedge-shaped in cross section, with a greatest thickness at the respective end areas opposite one another in the circumferential direction of the running wheel. A locking jaw results which, when viewed in the extension direction of the supporting surface, has, in cross section, a smaller thickness in a central area than in the end areas. In relation to the running surface of the running wheel, this may be achieved by an at least approximately coaxial course of the jaw surface facing the running surface, if necessary in interaction with a course of the supporting surface that is curved in the opposite direction in the cross section.

The thicknesses in the end areas may be selected to be the same and, for example, correspond to approximately 1.1 to 2 times, for example approximately 1.2 to 1.5 times, the thickness in the central area of the locking jaw.

The supporting surface of the locking jaw may, as is also preferred, be designed to be elongated in the circumferential direction of the running wheel. Furthermore, it may be formed by an upper side of one or more of one or more ribs and/or an upper side of a valley or valleys formed between two elevations, possibly the mentioned ribs.

In this case, the supporting surface may also be composed of several surfaces that are separate from one another in the circumferential direction of the running wheel and/or are transverse to the circumferential direction.

It is further preferred that the locking jaw has a retaining projection which is cantilevered transversely to its extension in the circumferential direction of the running wheel. By this means, it may be accommodated in an assigned holding receptacle of the locking element. The receptacle is preferably provided to be movable in the circumferential direction of the running wheel.

More preferably, two mounting projections are provided opposite one another transversely to the circumferential direction of the running wheel. Such a holding projection may also be composed of several individual projections, when viewed in the circumferential direction of the running wheel.

A holding projection is additionally preferably designed to be elongated in the circumferential direction of the running wheel. An elongated design here preferably means that an extension in the circumferential direction is greater than an extension of the holding projection transverse to the circumferential direction.

According to one further embodiment, the locking jaw may also only or additionally have (at least) one reinforcing part which interacts with the support surface. The reinforcing part may contribute to an increased stability of the adjusting device and/or to an improved transmission of force as a whole. It may be provided that the reinforcing part engages in the holding opening of the locking element and, if necessary, is also guided through the opening in order to interact with the support surface.

Furthermore, the reinforcing part may comprise a material that is different from the material of the locking jaw. A harder material is preferably selected for the reinforcing part, in comparison to the material of the locking jaw, in particular to improve transmission of force and to increase the abrasion resistance. Furthermore, for example, in one embodiment, the locking jaw (and preferably also the locking element) may comprise a plastic material, the reinforcing part may comprise a metal material.

The reinforcing part as a whole may, for example, as is also preferred, be rod-shaped, at least in the areas that interact with the elongated holding opening(s) or with the support surface(s). These rod-shaped sections (or also the entire reinforcing part) may, as is also preferred, have a circular cross-sectional design.

The locking jaw may be held on the locking element by means of the reinforcing part. Thus, preferably through a corresponding engagement of the reinforcing part in the slot-shaped holding opening, a path limitation may be achieved hereby with respect to the displacement of the locking jaw relative to the locking element, in addition to the preferably captive retention.

In one further preferred embodiment, two reinforcing parts are provided, arranged spaced apart from one another in the circumferential direction of the running wheel. The two reinforcing parts may engage in holding openings that are likewise spaced apart from one another in the circumferential direction of the running wheel or, alternatively, into one holding opening that is designed to accommodate both reinforcing parts simultaneously and is correspondingly elongated.

The wedge effect in the engagement position is facilitated by the proposed embodiment. Corresponding design measures preferably ensure that the locking element together with the locking jaw is initially guided onto the running surface and into the engagement position, perpendicular to the running surface of the running wheel. In this engagement position, the locking jaw may engage in the running surface using any toothing provided, if necessary, on the jaw surface. If the running wheel, which is thus basically blocked, is loaded in a direction of rotation, an entrainment of the locking jaw along the support surface results due to the interaction between the locking jaw and the running surface, which, due to the oppositely curved paths of the support surface and the jaw surface of the locking jaw, leads to a wedging of the locking jaw between the running surface and the locking element. The running wheel becomes increasingly blocked. A limitation of this entrainment is determined by the selected thickness of the locking jaw in the end areas, as well as by a possible abutment of a rod-shaped reinforcing part on the facing end the holding opening.

With the discontinuance of the load on the locking element, the locking jaw may be displaced back along the support surface into a central neutral position. This may be achieved by a spring correspondingly acting on the locking jaw.

With regard to a caster with a locking element as part of a toggle lever arrangement, it is further proposed that the lever parts each have a longitudinal axis and that, in the second position, the longitudinal axes together define an angle of less than 180°. In this second position, in which the engagement position is reached, the levers of the toggle lever arrangement are only displaced out of the first position via the end effector to the extent that an extended position of the lever parts or indeed an over-extended position of the lever parts (extended dead center) is not reached. Thus, in the first position (release position) of the lever parts, an angle of, for example, approximately 95° to approximately 130° may be adopted with respect to one another, and, in the second position (engagement position), an angle of, for example, approximately 115° to approximately 145° or up to approximately 160° may be adopted.

The end effector may, as is also preferred, act on the toggle lever arrangement in the area of the toggle joint which pivotally connects the lever parts. By applying a corresponding force over the course of a displacement of the end effector, the lever parts connected in the toggle joint are spread apart from one another, increasing the defined angle.

The end effector may thereby be designed as a separate element from the toggle joint arrangement. For example, the end effector may be an element that is basically provided in a steering caster of the type in question and may also function to perform other functions.

Thus, the insertion element may furthermore be a linearly-movable tappet—preferably along an axis that is vertical in normal operation—or, for example, a switching tappet guided in a mounting pin, via which, for example, in addition to the rotational blocking of the running wheel or alternatively thereto, a pivot blocking of the steering caster about the previously described vertical axis may also be carried out.

In one possible embodiment, the end effector may thereby be movable between a contact position, in particular on the toggle joint, and a distanced position with respect to the toggle lever arrangement. A complete unloading of the toggle lever arrangement in the release position may correspondingly result.

The displacement of the toggle-lever assembly into the engagement position of the locking jaw is preferably carried out counter to the return force of a return spring acting on the toggle lever arrangement.

Even in the case of a previously described toggle lever arrangement, the locking jaw, in particular, which is preferably provided in an articulated manner on the lever-like locking element, is linearly guided in such a way that it may be displaced substantially perpendicularly towards the running surface of the running wheel.

With regard to the disclosure, the previously and subsequently specified ranges or value ranges or ranges of multipliers also include all intermediate values, in particular in 1/10 increments of the respective dimension, and, if necessary, also dimensionless. For example, the indication 115° to 145° also includes the disclosure of 115.1° to 145°, 115° to 144.9°, 115.1° to 144.9° etc.; the disclosure of 3 to 5 mm also includes the disclosure of 3.1 to 5 mm, 3 to 4.9 mm, 3.1 to 4.9 mm et cetera. On the one hand, this disclosure may function to delimit a specified range boundary from below and/or above; however, alternatively or additionally it may also function to disclose one or more singular values from a respectively specified range.

The invention is subsequently explained with reference to the accompanying drawings, which, however, merely depict exemplary embodiments. A part, which is only explained in relation to one of the exemplary embodiments and is not replaced by another part in another exemplary embodiment due to the special feature identified there, is thus also described as an at least possibly present part for this further exemplary embodiment.

### BRIEF DESCRIPTION OF THE DRAWINGS

As shown in the drawings:

FIG. 1 a caster in an exploded perspective depiction, relating to a first embodiment;

FIG. 2 the caster of the first embodiment in a partially sectional perspective depiction;

FIG. 3 area III in FIG. 1 in an exploded perspective depiction, relating to a locking assembly of the caster of the first embodiment;

FIG. 4 the sectional depiction through plane IV in FIG. 1;

FIG. 5 sectional depiction V-V in FIG. 2, relating to a release position of the caster;

FIG. 6 a sectional depiction according to FIG. 5, but relating to a pivot blocking position;

FIG. 7 a further sectional depiction according to FIG. 5, relating to a position in total locking;

FIG. 8 area VIII in FIG. 7 in a sectional depiction offset perpendicular to the plane of representation, relating to an initial blocking position of a locking jaw of the locking assembly;

FIG. 8a a schematic depiction of the wedge effect of the locking jaw in a position according to FIG. 8;

FIG. 9 a depiction essentially corresponding to FIG. 8; however, relating to a final blocking position;

FIG. 9a a depiction essentially corresponding to FIG. 8a; however, corresponding to the position according to FIG. 9;

FIG. 10 a further depiction essentially corresponding to FIG. 8, relating to a further final blocking position;

FIG. 10a a further schematic depiction essentially corresponding to FIG. 8a, relating to the position according to FIG. 10;

FIG. 11 a locking element of the locking assembly in a side view;

FIG. 12 the locking element in a top view;

FIG. 13 the locking element in an individual perspective depiction;

FIG. 14 the locking jaw of the locking assembly in an end view;

FIG. 15 the locking jaw in a side view;

FIG. 16 the locking jaw in an individual perspective depiction;

FIG. 17 a lever part of the locking assembly in an individual perspective depiction;

FIG. 18 a partially sectional perspective depiction according to FIG. 2, relating to a caster in a second embodiment;

FIG. 19 a locking assembly of the caster of the second embodiment in an exploded perspective depiction according to FIG. 3;

FIG. 20 the sectional depiction of area XX in FIG. 18, relating to a release position of the caster;

FIG. 21 a depiction essentially corresponding to FIG. 20; however, relating to a position in total locking;

FIG. 22 the sectional view through plane XXII in FIG. 18;

FIG. 23 a locking jaw of the locking assembly of the second embodiment in an end view;

FIG. 24 the locking jaw in a side view;

FIG. 25 the sectional view along line XXV-XXV in FIG. 24;

FIG. 26 the locking jaw of the second embodiment in an individual perspective depiction;

FIG. 27 a second lever part of the locking assembly of the second embodiment in a side view;

FIG. 28 the second lever part in a top view;

FIG. 29 the second lever part in an individual perspective depiction;

FIG. 30 a locking element of the locking assembly of the second embodiment, designed as a first lever part, in an individual perspective depiction;

FIG. 31 a sectional depiction essentially corresponding to FIG. 20; however, relating to a third embodiment;

FIG. 32 a depiction essentially corresponding to FIG. 5 referring to a fourth embodiment of the locking element and the locking jaw;

FIG. 33 the fourth embodiment in a depiction according to FIG. 8, relating to an initial blocking position;

FIG. 33a a depiction corresponding to FIG. 8a, but relating to the fourth embodiment;

FIG. 34 a depiction essentially corresponding to FIG. 33, but relating to a final blocking position;

FIG. 34a a depiction essentially corresponding to FIG. 33a; however, relating to the position according to FIG. 34;

FIG. 35 a further depiction essentially corresponding to FIG. 33, relating to a further final blocking position;

FIG. 35 a further depiction essentially corresponding to FIG. 33a; however, relating to the position according to FIG. 35;

FIG. 36 the locking element of the locking assembly of the fourth embodiment in a side view;

FIG. 37 the locking element of the fourth embodiment in a top view;

FIG. 38 the locking element of the fourth embodiment in a bottom view;

FIG. 39 the locking element of the fourth embodiment in an individual perspective depiction;

FIG. 40 the locking jaw of the locking assembly of the fourth embodiment in an end view;

FIG. 41 the locking jaw of the fourth embodiment in a side view;

FIG. 42 the locking jaw of the fourth embodiment in a top view;

FIG. 43 the locking jaw of the fourth embodiment in a bottom view;

FIG. 44 the locking jaw of the fourth embodiment with an assignable spring in a perspective depiction;

FIG. 45 a lever part of the locking assembly in an individual perspective depiction;

FIG. 46 the locking assembly of the fourth embodiment in a top view;

FIG. 47 the sectional view through the locking assembly of the fourth embodiment according to line XLVII-XLVII in FIG. 46; and;

FIG. 48 the locking assembly of the fourth embodiment in a perspective depiction.

### DESCRIPTION OF THE EMBODIMENTS

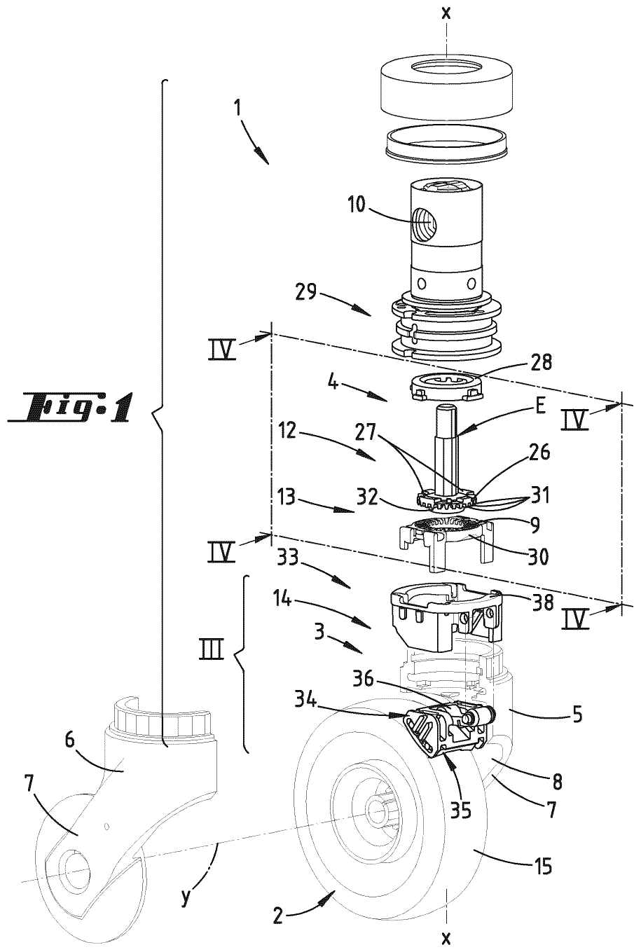

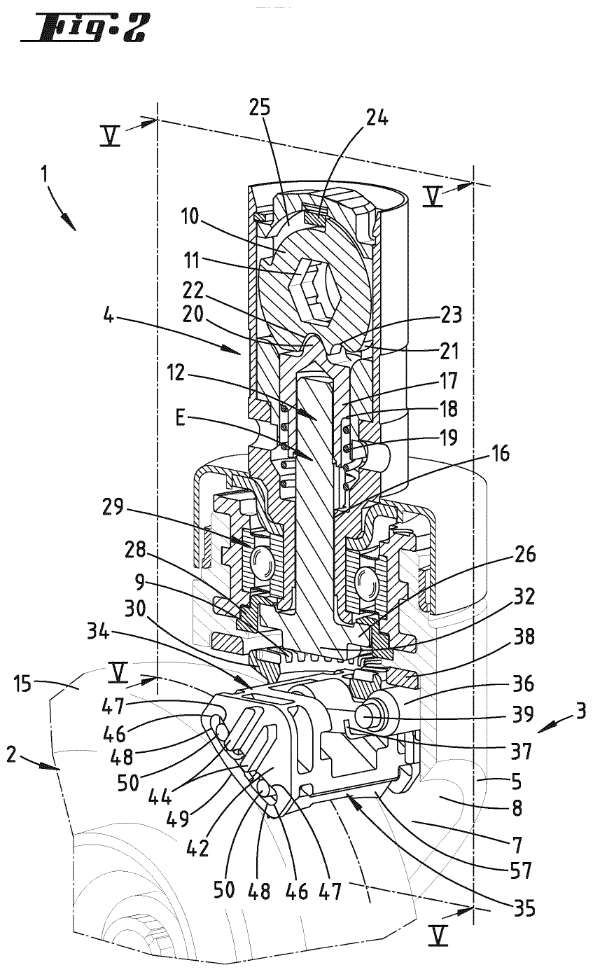

Depicted and described, initially with reference to FIGS. 1 and 2, is a caster 1, which is preferably designed as a type of steering caster in the depicted embodiments.

Caster 1 essentially has a running wheel 2 with a running surface 15 having a circumferential direction U, and a fork 3 from which a cylindrical mounting pin 4 extends. Mounting pin 4 surrounds a geometric pivot axis x in a pivotable embodiment with respect to a swivel caster. Mounting pin 4 protrudes vertically further upwards in relation to running wheel 2 when caster 1 is in the normal operating state.

Fork 3 may be, as also depicted, essentially formed from two fork shell parts 5, 6, wherein each fork shell part 5, 6 supports a fork leg 7.

Fork shell parts 5, 6 of fork 3 grasp running wheel 2, mounted in fork cavity 8 preferably intended therefor, with their fork legs 7, which are preferably substantially congruent in the direction of an axis of rotation y of running wheel 2. An axle may function for mounting running wheel 2, centrally traversing running wheel 2 and being preferably supported at each respective end on fork legs 7. The resulting geometric axis of rotation y of running wheel 2 extends preferably and substantially transversely to pivot axis x and thus substantially in a horizontal plane during normal use of caster 1.

Depicted caster 1 may be positioned, for example, on a hospital bed, a transfer car, or the like. The fixing may be carried out in the usual way by using mounting pin 4.

A switching cam 10 arranged to be pivotable about an actuating axis a may additionally be provided in mounting pin 4 in the area of an upward facing free end. Actuating axis a may thereby extend substantially perpendicular in an embodiment as a steering caster. In an embodiment as a non-pivoting caster, also called a fixed caster, pivot axis x corresponds to a vertical axis of the mounting pin. As far as a pivot axis has been previously or will be subsequently mentioned, this is always to be understood as the vertical axis referred to with regards to a non-pivoting embodiment. Switching cam 10 may have, for the entrainment of cam 10, a centrally arranged, non-circular, coupling opening 11, if applicable, hexagonal according to the exemplary embodiment depicted, which may be traversed by a shift lever shaft (not depicted) for actuation.

With reference to the depiction in FIG. 5, for example, a switching tappet 12, via which a pivot locking device 13 and/or a running wheel locking device 14 may be actuated or released, may be provided underneath switching cam 10.

Switching tappet 12 is oriented in mounting pin 4 preferably about pivot axis x and is thereby preferably vertically displaceable along pivot axis x and secured against rotation. For this purpose, mounting pin 4 may have a passage 16 with a reduced diameter, which is likewise preferably oriented about pivot axis x, which may, if applicable, be adapted in cross section to switching tappet 12 for guiding.

As FIG. 5 shows, for example, the free end of switching tappet 12, formed between the opening of passage 16 and switching cam 10, may be screw-connected, for example, to a cam part 17. Cam part 17 may hereby preferably have a pot-like shape with a more preferably circular cross section, wherein an area with an increased diameter may be formed on the end facing away from switching tappet 12 as an annular collar 18. In addition, cam part 17 of switching tappet 12 is preferably guided vertically along pivot axis x within mounting pin 4 in relation to the depictions.

In addition, the section of cam part 17 with a reduced diameter, in comparison to annular collar 18, may be surrounded by a first return spring 19, wherein one end of first return spring 19 may be supported on the underside of annular collar 18. The other opposite spring end may be supported on an edge of passage 16 which is stationary relative to cam part 17. It may thus be provided that switching tappet 12 is spring-loaded in the direction of switching cam 10 by means of first return spring 19. In addition, as is also preferred, the end face of optionally provided annular collar 18, which faces switching cam 10, may have a central shape in the form of a counter-cam 20.

Switching tappet 12 with preferably provided counter-cam 20 interacts with facing control surface 21 of switching cam 10, which control surface 21 may additionally have two control recesses 22 and 23, of different depths with respect to the radial distance from actuating axis a and arranged one behind the other in the circumferential direction of switching cam 10.

Switching cam 10 is stop-limited in its pivoting movement when viewed in the circumferential direction of control surface 21. For this purpose, a stop projection 24 on the mounting pin side may engage, as depicted, in a correspondingly provided circumferential groove 25 of switching cam 10. As is clear, for example, from the depiction in FIG. 5, circumferential groove 25 is provided substantially opposite control recesses 22 and 23 in relation to actuating axis a, wherein circumferential groove 25, extending in the circumferential direction, additionally extends across an angular range of approximately 90°.

Switching tappet 12, when viewed in the direction of running wheel 2, preferably extends in the direction of fork cavity 8 or up into the same. Fork cavity 8 preferably surrounds a shape of switching tappet 12 that is circular in cross section, which shape may be larger in diameter than an upper area of switching tappet 12. The shape may assume the function of a locking plate 26, which, in the case of an embodiment as a pivot caster, may be formed on switching tappet 12 surrounding pivot axis x transversely to the same.

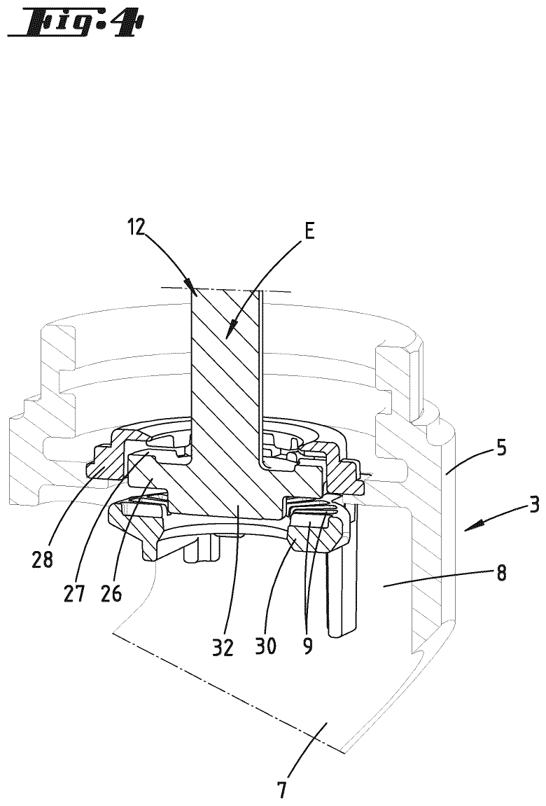

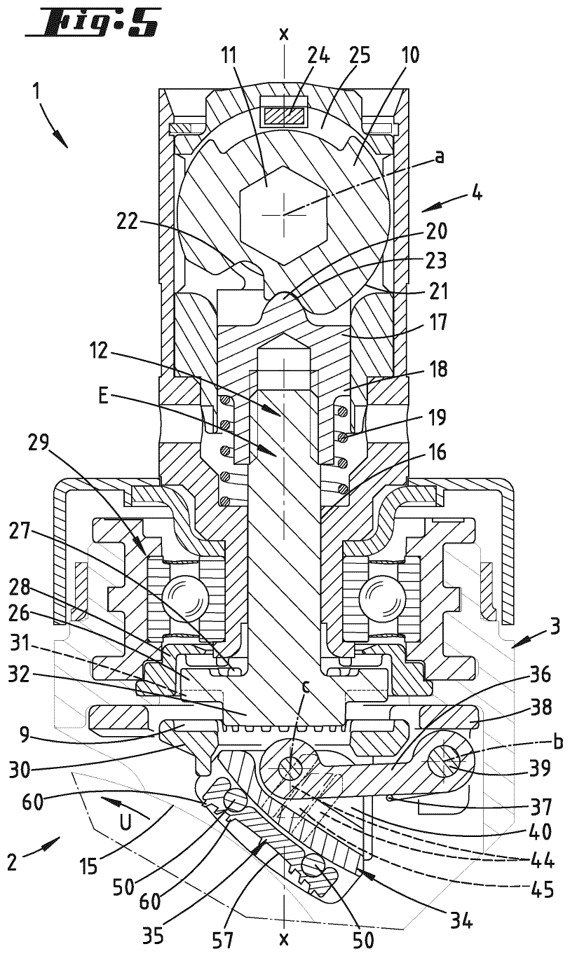

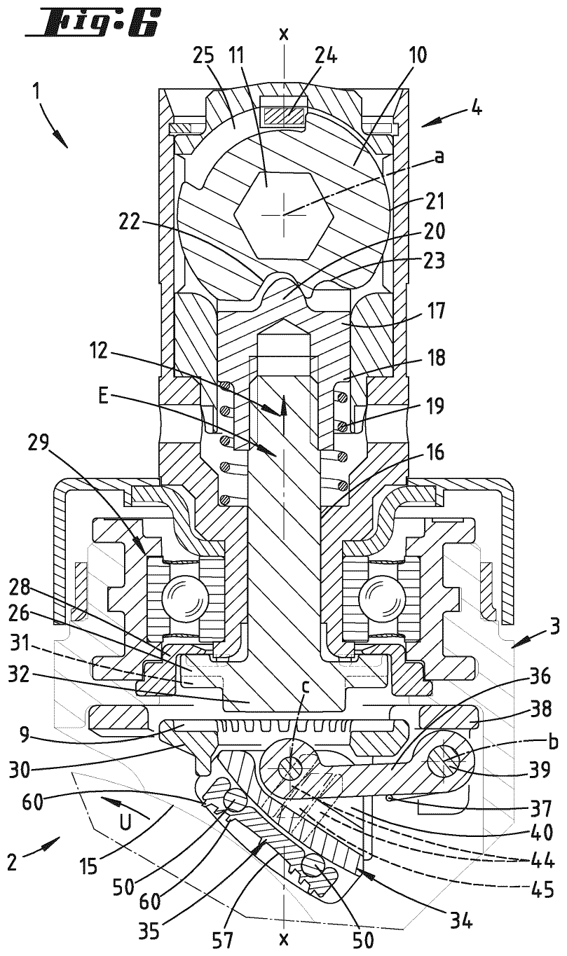

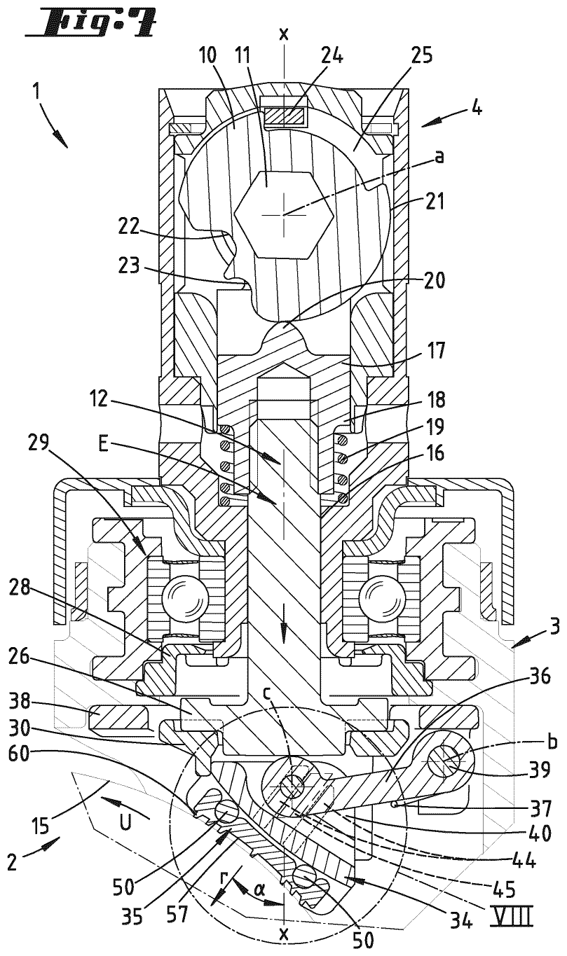

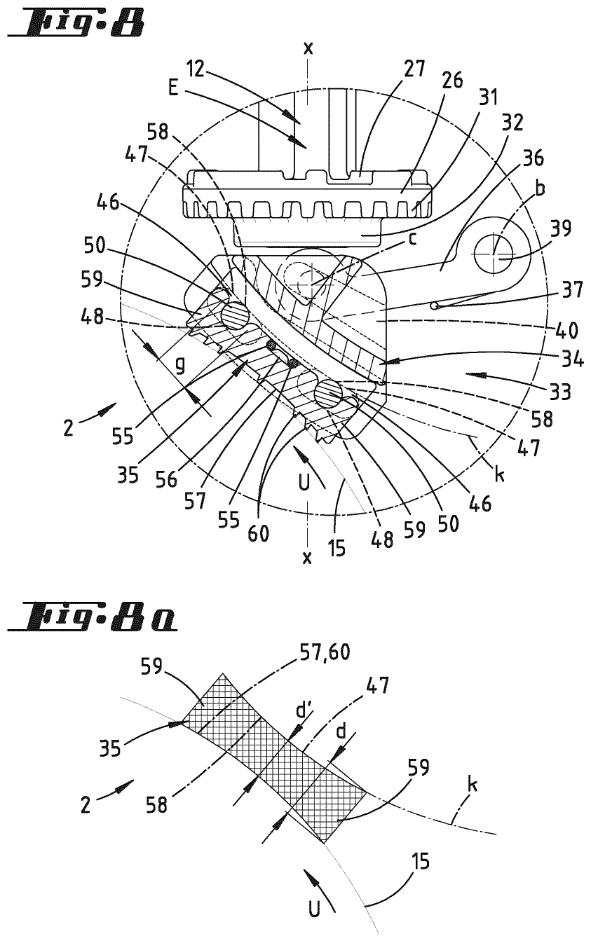

Locking plate 26 may have locking formations 27 on its plate surface facing switching cam 10. In a so-called fixed caster position, as this is assumed, for example in FIG. 6, in which fork 3 with running wheel 2 may preferably only assume two positions relative to mounting pin 4 which are offset by 180° from one another, these locking formations 27 may be pressed evenly against the underside of a directional locking part 28 by the spring force of first return spring 19. Directional locking part 28 may thereby be fixed, in particular, on fork 3, additionally, for example, in an area in which fork 3 is held as a whole on mounting pin 4 via a bearing 29 and is pivotable about pivot axis x relative to said mounting pin.

Locking plate 26 with its locking formations 27, direction locking part 28, and a rotation blocking part 30, subsequently described in more detail, are essentially part of pivot locking device 13.

The fixed caster position may be adopted by rotating switching cam 10 into an interacting position of counter-cam 20 with control recess 23, or another equivalent shape (cf. FIG. 6). In comparison with the neutral position shown in FIG. 5, in which counter-cam 20 engages in additional control recess 22, the fixed caster position may, with reference to the figures, thereby cause a lifting of cam part 17 and of switching tappet 12, and thus also of locking plate 26, into the interacting position with directional locking part 28, as a result of the spring force applied via first return spring 19.

Switching tappet 12 may additionally have rotation blocking projections 31 on the underside of locking plate 26 facing away from locking formations 27. These rotation blocking projections may additionally extend, for example, coaxially to pivot axis x and in the circumferential direction of locking plate 26.

Starting from locking plate 26, when viewed in the direction of running wheel 2, a preferably circular, more preferably cylindrical extension 32 with a reduced diameter compared to locking plate 26 may arise from switching tappet 12 and may, in turn, be inserted for technical guiding in a centrally arranged through opening of rotation blocking part 30 arranged about pivot axis x, or may engage with the same. Rotation blocking part 30, inserted in fork cavity 8 between running wheel 2 and locking plate 26, may, like directional locking part 28, be likewise non-rotatably mounted using fork 3.

Rotation blocking part 30 may have blocking receptacles 9 adapted to the geometry of rotation blocking projections 31. Rotation blocking part 30 is preferably supported on the fork side via spring elements acting substantially in the direction of pivot axis x.

As a result of the interaction of rotation blocking projections 31 of locking plate 26 and blocking receptacles 9 in rotation blocking part 30, caster 1, in an embodiment as a pivot caster, may be fixed in different pivot positions about pivot axis x. For this purpose, switching cam 10 may be pivoted about its actuating axis a into a position in which counter-cam 20 contacts control surface 21 of switching cam 10 extending radially outward in the circumferential direction, according to the depiction in FIG. 7. Counter-cam 20 may be moved, together with switching tappet 12, against the force of first return spring 19, downward with respect to the depictions. Rotation blocking projections 31 may engage into associated blocking receptacles 9 to prevent pivoting.

At the same time, as is also preferred, a rotational locking of running wheel 2 may also be achieved in this position. Running wheel locking device 14 functions for this purpose. Running wheel locking device 14, described in more detail below, deviates from the described depictions in that it is also usable alone, that is, if necessary, without a possible pivot locking of caster 1 about pivot axis x. Thus, for example, in one possible embodiment, caster 1, as already noted, may be designed as a whole as a fixed caster, i.e., it may have no possibility of assuming a fixed caster position (as is preferred in the design as a pivot caster), for which purpose, for example, switching cam 10 may only have one distinct control recess 22 for defining the neutral position, and switching cam 10 may only be rotated in one direction out of this neutral position in order to reach a second switching position in which running wheel locking device 14 is activated.

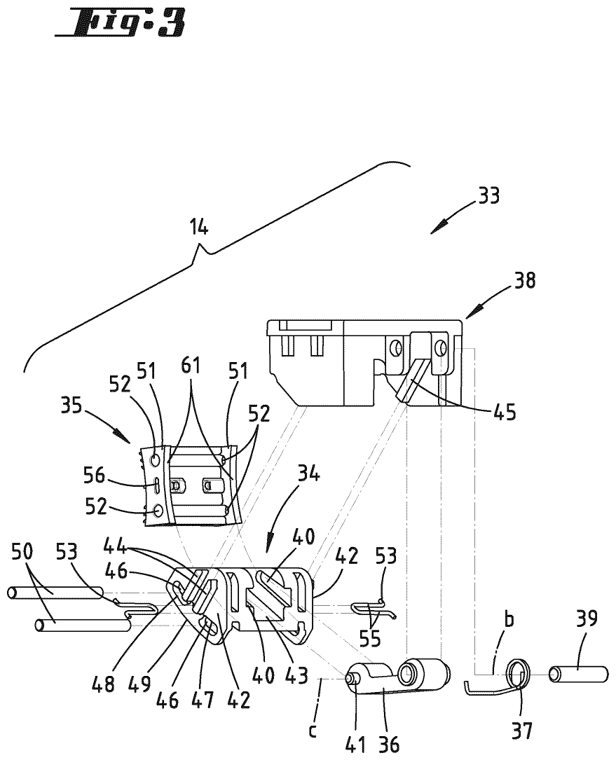

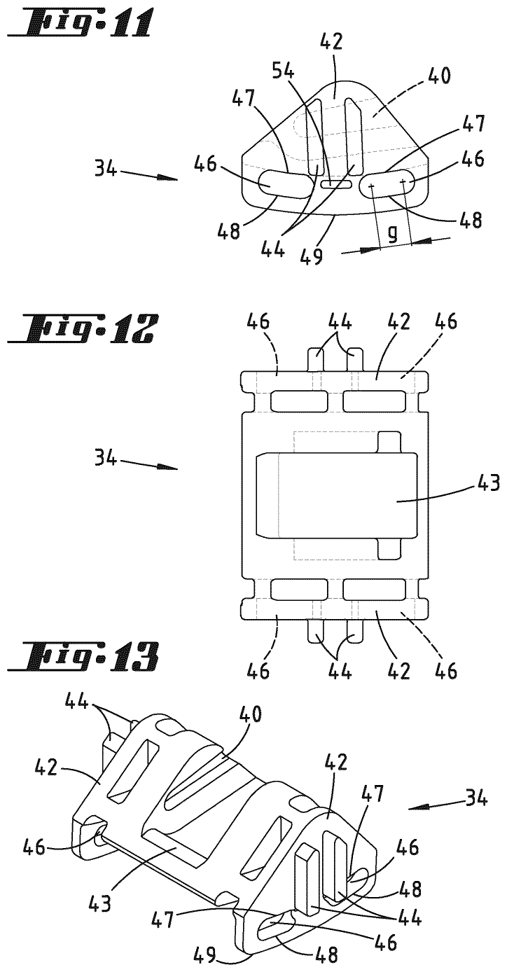

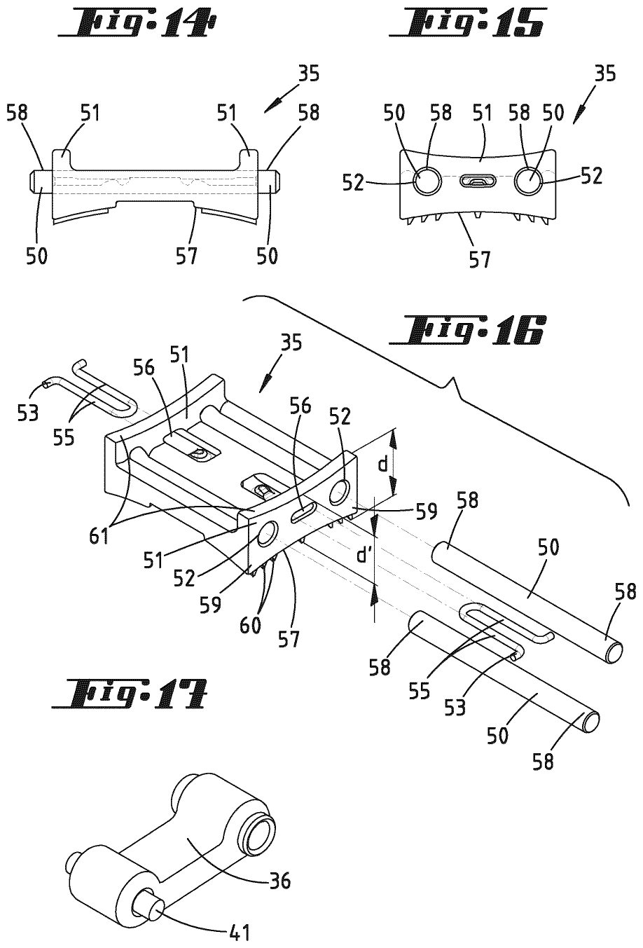

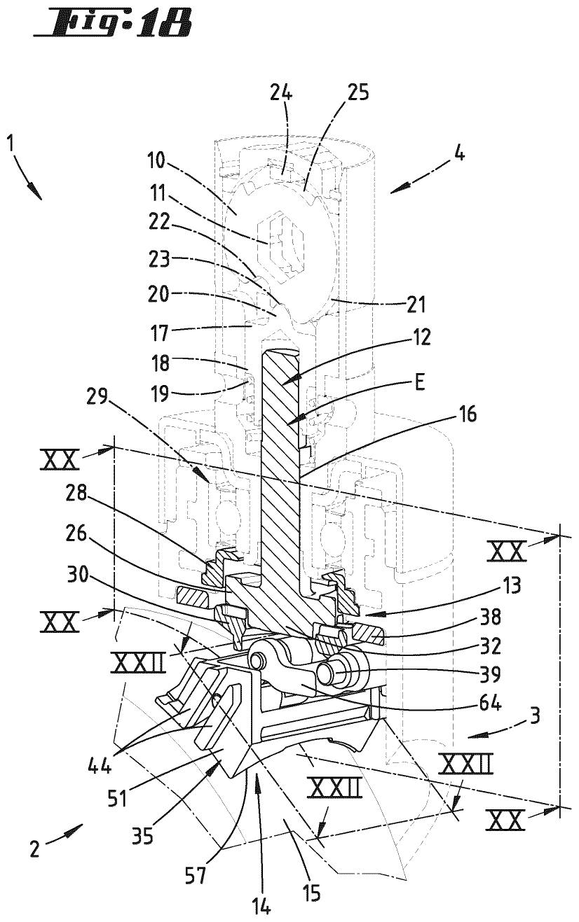

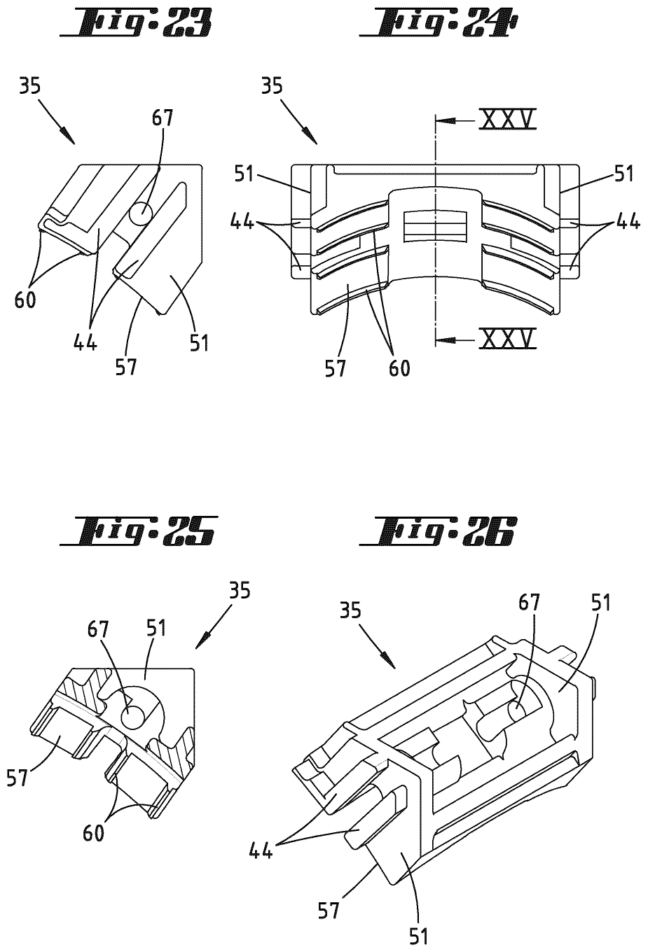

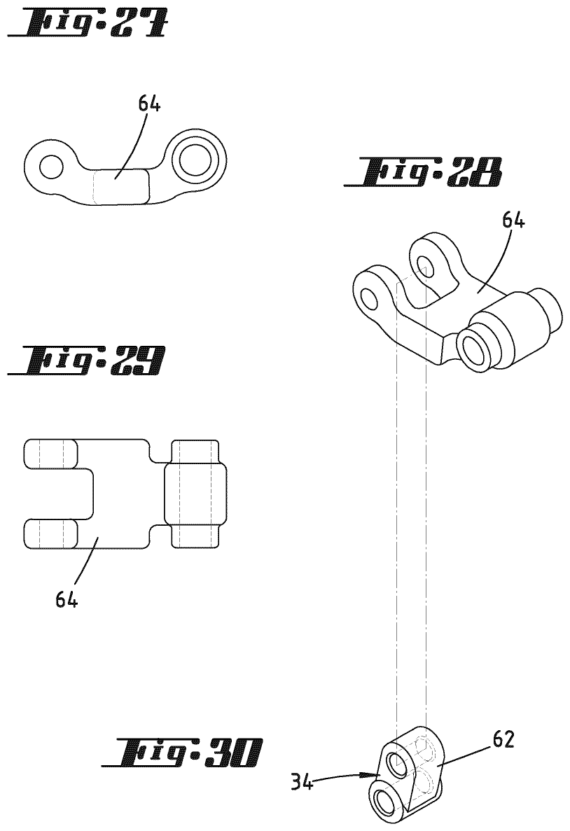

FIGS. 1 to 17 show a first embodiment of such a running wheel locking device 14, FIGS. 18 to 30 show a second embodiment and FIG. 31 shows a combination of the two first embodiments as a third embodiment.

Running wheel locking device 14 initially has a locking assembly 33, with a holding part 38, a locking element 34 and a locking jaw 35, a lever part 36 and a second return spring 37. This locking assembly 33 may advantageously be inserted pre-assembled into fork 3. Holding part 38, which preferably essentially holds the other listed components, is thereby preferably arranged in fork 3 in a rotationally fixed manner with respect to pivot axis x.

With initial reference to the first embodiment, lever part 36 is pivotably mounted on holding part 38. For this purpose, an axle 39, which is accommodated at each end in holding part 38, for example, may function to pivot lever part 36 about its geometric pivot axis b, which preferably runs aligned with axis of rotation y of running wheel 2.

The end of lever part 38 facing away from the end accommodating axle 39 is located, for example using axle journals 41, in a likewise pivotable receptacle in locking element 34, for example in slot receptacles 40 of locking element 34. Related geometric pivot axis c runs in a parallel orientation to pivot axis b mentioned above.

Locking element 34 may have two guide walls 42 spaced apart from one another in the direction of pivot axis c. These are, if necessary, preferably rigidly connected to one another via a core section 43 which also has aforementioned slot receptacles 40.

One or two guide parts, preferably two guide ribs 44, may be formed on the outside wall side of respective guide walls 42, and which, spaced apart from one another accommodate between themselves a counter part, preferably formed on holding part 38 and designed, for example, as a counter rib 45. A linear guiding of locking element 34 on holding part 38 is thus substantially provided. Direction of movement r between a release position, depicted in FIGS. 5 and 6, and an engagement position, depicted in FIG. 7, preferably extends defining an angle α of approximately 30 to 60°, further approximately 45°, with pivot axis x. Thus, and also as a result of the selected arrangement of holding part 38 in fork 3, an advancing of locking element 34 together with locking jaw 35 arranged thereon, substantially in the direction perpendicular to running surface 15 of running wheel 2, is achievable.

Like locking element 34, locking jaw 35 is also preferably manufactured from a plastic material, thus, for example, produced in a plastic injection molding process.

To hold locking jaw 35 on locking element 34, holding openings, for example elongated slot-like holding openings 46, may be provided in side walls 42 of locking element 34. Two holding openings 46 may be provided, as is also preferred, spaced apart from one another in the longitudinal direction of one holding opening 46 or in circumferential direction U of running wheel 2, for each side wall 42.

With reference to a cross section in which axis of rotation y of running wheel 2 is depicted as a point, further, for example in a cross section according to FIG. 8, support surfaces 47 arise in holding openings 46 of a side wall 42, which face away from running surface 15 of running wheel 2, and which mutually extend along an imaginary line of curvature k. This line of curvature k extends, with reference to the cross-sectional depiction, curved in the direction opposite the curvature of running surface 15. Lines of curvature k and running surface 15 thereby have at least approximately the same radii. In one preferred embodiment, line of curvature k has a radius that may correspond to approximately 0.8 to 1.2 times the running surface radius.

More preferably, limiting surface 48 of one holding opening 46 opposite respective support surface 47 extends along a line running coaxially to line of curvature k.

Holding openings 46 may, as also depicted, be spaced apart from one another in the extension direction of line of curvature k or in circumferential direction U of running wheel 2 by a dimension that substantially corresponds to the extension dimension of the opening of a holding opening 46 in the same direction.

Holding openings 46 of both side walls 42 lie in a projection in the direction of pivot axis c, correspondingly in a projection perpendicular to the viewing plane in FIG. 8, preferably congruently one above the other.

An underside 49 of each side wall 42 facing running surface 15 may likewise, as is also preferred, extend along a line coaxial with line of curvature k.

Locking jaw 35 is accommodated between side walls 42. The receiving assembly is achieved via rod-shaped reinforcing parts 50. These reinforcing parts 50 are preferably manufactured from a harder material in comparison to the material of the locking jaw material and also preferably in comparison to the material of the locking element. Thus, for example, these reinforcing parts 50 may, as is also preferred, comprise a metal material.

Two rod-shaped reinforcing parts 50 are preferably provided, which pass through side flanks 51 of locking jaw 34 in the area of bore-like penetrations 52 and respectively engage with their ends in previously described holding openings 46 of locking element 34.

The diameter of rod-shaped reinforcing parts 50 is preferably adapted to both the diameter of the bore-like penetrations 52 and also to the radial distance (with respect to line of curvature k) between a support surface 47 and an opposite limiting surface 48 of a holding opening 46.

The surface of a reinforcing part 50 on the locking jaw side facing each support surface 47 forms a supporting surface 58 for locking jaw 35 on support surface 47 of locking element 34. As a result of a preferred circular cross-sectional design of reinforcing part 48, a linear support preferably results on support surface 47.

Locking jaw 35 is correspondingly float-mounted in slot-shaped holding openings 46 of locking element 34 in circumferential direction U, and may move within holding openings 46 substantially transversely to direction of movement r of locking element 34.

A central alignment of locking jaw 35 relative to locking element 34 is preferred, particularly in an unloaded initial position according to FIGS. 5 and 6. In this unloaded initial position, rod-shaped reinforcing parts 50 correspondingly extend approximately centered in the longitudinal extension of holding opening 46. This initial centered position may be achieved by spring action, for which purpose, for example, a preferably omega-shaped spring 53 may be provided and respectively assigned to a side wall 42.

Each spring 53 engages from the outside through a slot opening 54 in the assigned side wall 42 and plunges with its spring legs 55, which preferably run parallel and spaced apart from one another, into a respective receiving pocket 56 between penetrations 52 of a side flank 51. Spring legs 55 thereby contact the side edges of receiving pocket 56 for the preferred centering in the middle of locking jaw 35 on locking element 34.

In the cross section described above, locking surface or jaw surface 57 of locking jaw 35, facing in the direction of running wheel 2, extends adapted to the curvature of running surface 15. In conjunction with an upper side 61 of locking jaw 35, which is adapted to the course of the line of curvature k, more particularly in conjunction with an imaginary line of curvature along which supporting surfaces 58 arise, locking jaw 35 is designed as a double wedge shape in cross section, with a greatest thickness d in respective opposite end areas 59 in circumferential direction U of running wheel 2. Approximately in the middle in this circumferential direction U, locking jaw 35 has a thickness d′, which may correspond, for example, to approximately 0.5 to 0.8 times edge thickness d (comp. also FIG. 8a).

Jaw surface 57 thereby extends curved essentially in the opposite direction to line of curvature k.

In addition, jaw surface 57 may support sawtooth-like projections 60 projecting past a substantially smooth surface. These are more preferably designed as one piece and integrally with locking jaw 35.

This may thereby result in two groups of projections 60, wherein, within one group assigned substantially in the end side of jaw surface 57 in the circumferential direction, projections 60 extend in the same direction in a sawtooth-like manner. In contrast, the groups of projections 60 are arranged such that their projections 60 face away from one another, respectively oriented further outwards in circumferential direction U.

By lowering switching tappet 12, which forms an end effector E for running wheel locking device 14, from the neutral position according to FIG. 5 or from the fixed caster position according to FIG. 6, preferably with simultaneous engagement of rotation blocking projections 31 into blocking receptacles 9 of rotation blocking part 30, a targeted impingement on lever part 36 is achieved by extension 32. This impingement acts in particular directly on the end of lever part 36 having pivot axis c.

In the course of the downward movement of switching tappet 12 (end effector E), locking element 34 and locking jaw 35 held thereon are acted upon indirectly via lever part 36 guided in slot receptacle 40, so that, as a result of the described linear guiding, there results a linear displacement of locking element 34 and locking jaw 35 in direction of movement r onto running surface 15. In particular, locking jaw 35 is thus moved from a release position into an engagement position according to FIGS. 7 and 8. Sawtooth-like projections 60, however, if necessary also at least partially jaw surface 57, are brought into an engagement position with running surface 15, which position is loaded by switching tappet 12.

The pivoting displacement of lever part 36 about pivot axis b thereby induced is carried out counter to the return force of second return spring 37, which, for example, as also depicted, may be designed as a leg spring, wherein one spring leg is also lever part 36 and one spring leg preferably acts against the holding part 38 fixed on the fork.

The superimposed pivoting and linear displacement of lever part 36 and locking element 34 is enabled by the guiding of lever part 36 in the slot receptacle 40 by means of its axle journal 41.

Due to the design of support surfaces 47, elongated in circumferential direction U of running wheel 2 or along line of curvature k, a movement is enabled of only locking jaw 35 relative to locking element 34 in circumferential direction U out of this (first) engagement position, which corresponds to an initial blocking position (see FIGS. 7 and 8), at a corresponding load of running wheel 2 in the direction of rotation, into a final blocking position, in order to thus further increase the application of force on running surface 15 due to the self-adjusting wedge effect.

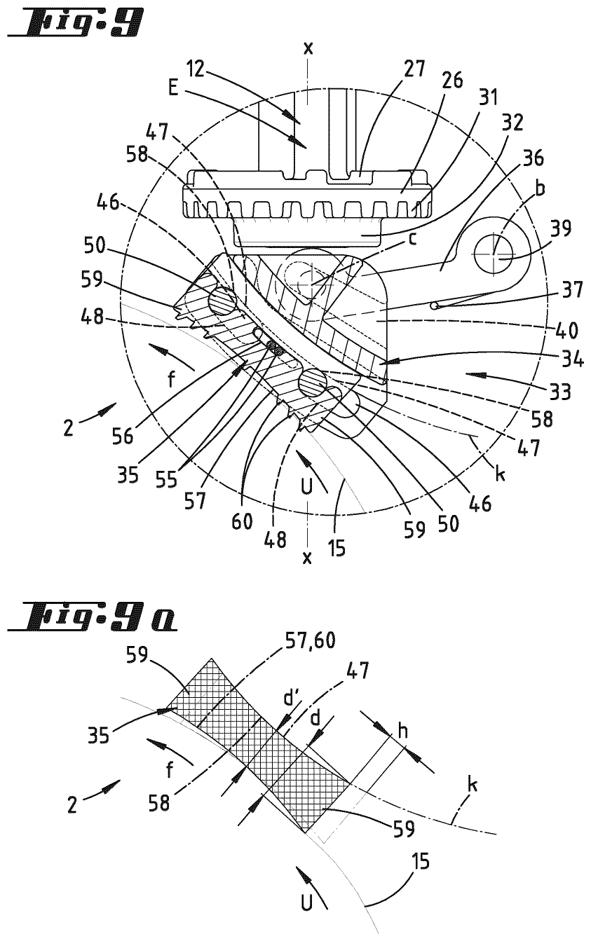

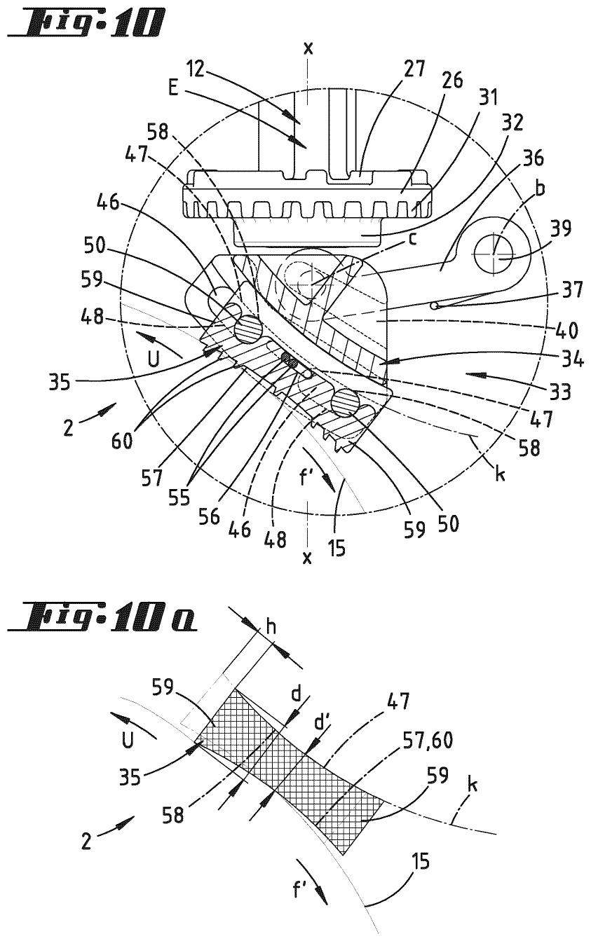

FIGS. 9 and 10 show the two (maximum) possible final blocking positions of locking jaw 35 at a load f acting in circumferential direction U (counterclockwise with respect to the depiction in FIG. 9), and at a load f′ (clockwise with respect to the depiction in FIG. 10). There results an entrainment of locking jaw 35 in the same direction of the load due to the frictional engagement, with a corresponding guiding of locking jaw 35 via its rod-shaped reinforcing parts 50 in the holding openings 46.

Respective support surface 47 has an effective length g, when viewed in circumferential direction U or in the direction of line of curvature k. At a preferred central position of locking jaw 35 in the initial blocking position according to FIG. 8 and according to the schematic depiction depicted in FIG. 8a, there results from this a maximum possible degree of displacement h of locking jaw 35 with its supporting surface 58 in both possible directions f and f′, which degree of displacement h substantially corresponds to half of length g.

According to one possible embodiment, at a length g of support surface 47 of, for example, approximately 3 to 5 mm, there results a degree of displacement h of, for example, approximately 1.5 to 2.5 mm. With respect to axis of rotation y of running wheel 2, an offset from the center position may result from this, for example, of approximately 1.5° to 3°.

The schematic depictions of FIGS. 9a and 10a respectively show the wedge effects at a displacement of locking jaw 35 corresponding to FIGS. 9 and 10.

The engagement position (regardless of whether an initial blocking position or a final blocking position is assumed) may only be maintained under constant application of force by end effector E or switching tappet 12 on lever part 36. With the suspension of this application of force due to the lifting of switching tappet 12, locking element 34 together with locking jaw 35 is displaced back into the release position spaced apart from running surface 15 via second return spring 37.

In the second embodiment shown in FIGS. 18 to 30, locking element 34 acting on locking jaw 35 is designed as a first lever part 62 of a toggle-lever assembly 63.

In this embodiment, toggle lever arrangement 63, which further has a second lever part 64, is also, together with locking jaw 35, a holding part 38 and a second return spring 37, part of a locking assembly 33 (see also FIG. 19), which may be inserted into fork 3 preassembled as such an assembly.

Both lever parts 62 and 64 of toggle lever arrangement 63 are articulatedly connected to one another in a toggle joint 65. Geometric pivot axis c resulting therefrom extends, as geometric pivot axis b of second lever part 64 also more preferably extends in the articulation area of holding part 38, preferably aligned with axis of rotation y of running wheel 2.

Facing away from the area of toggle joint 65, first lever part 62 substantially forming locking element 34, supports an axle 66 with a geometric pivot axis m, whose outwardly projecting free ends engage in adapted receptacles 67 of locking jaw 35. Receptacles 67 may, as preferred, be provided in the area of side flanks 51 of locking jaw 35.

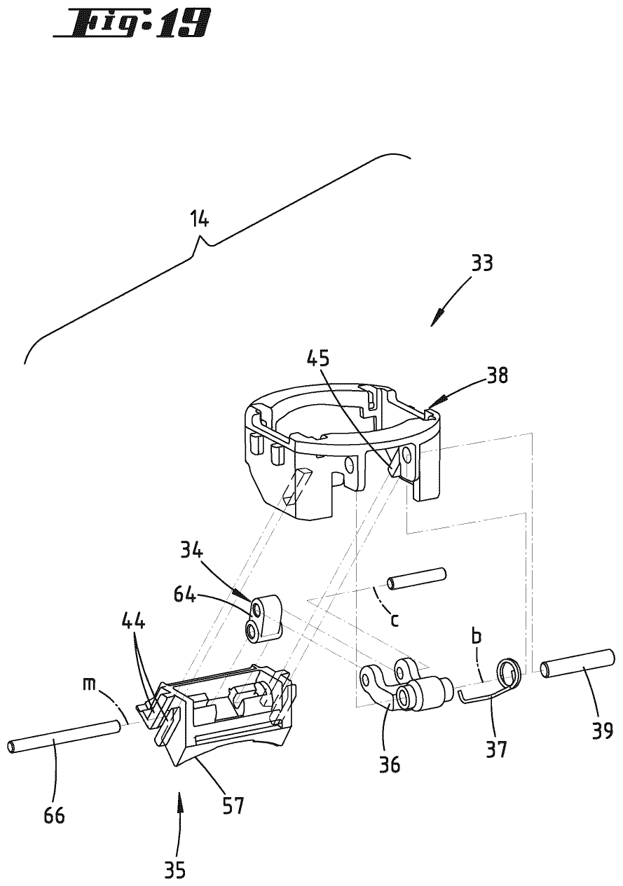

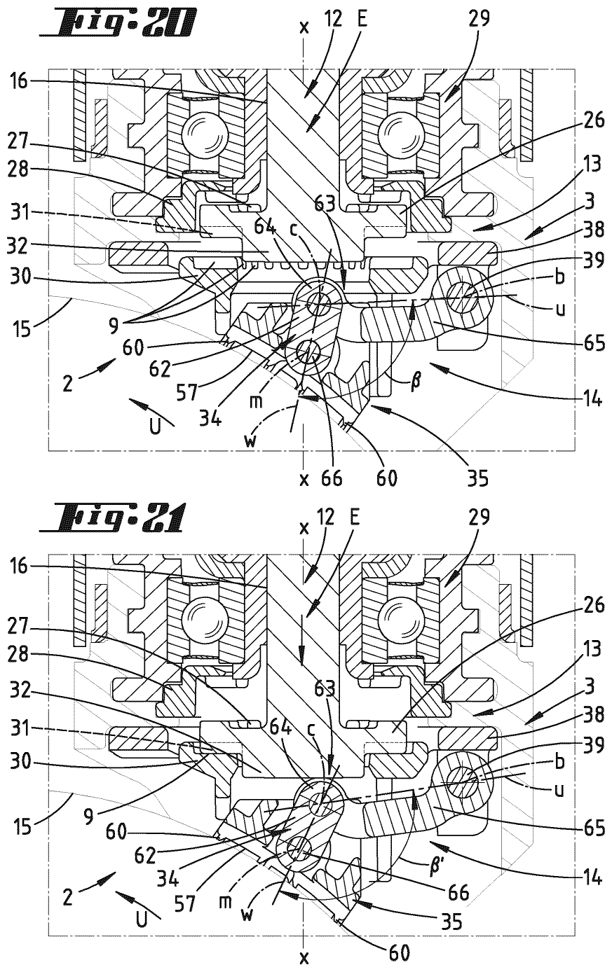

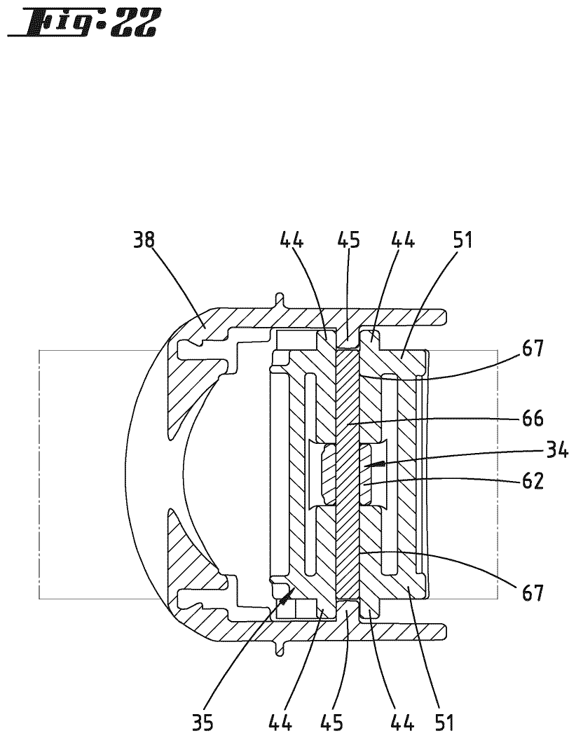

Two guide ribs 44, which extend parallel to one another, are preferably formed on locking jaw 35 on the outside wall side of these side flanks 51, and which interact with adapted counter ribs 35 of holding part 38 for the linear guiding of locking jaw 35 in direction of movement r (comp. FIG. 22). By this means, a preferred direction of displacement is achievable for locking jaw 35 substantially in a direction perpendicular to running surface 15.

Also in this embodiment, locking jaw 35 is provided with sawtooth-like projections 60 on the underside of jaw surface 57.

The part acting on toggle joint arrangement 63 for displacement is not directly part of toggle joint arrangement 63, but instead is a separate part which is advanced through displacement for the impingement. For this purpose, as in the previously described embodiment, switching tappet 12 is preferably used as an end effector E. Its effect with respect to achieving a neutral position of the caster or a fixed caster position is as described above.

By lowering switching tappet 12, also in this case, if necessary, with the simultaneous engagement of blocking receptacles 9 and rotation-blocking projections 31, the area of toggle joint 65 is acted upon via extension 32 in such a way that the toggle lever arrangement is moved out of a release position, with a first, more strongly angled position of lever parts 62 and 64 relative to one another according to FIG. 20, and into a second, less angled position (engagement position) of the lever parts relative to one another according to FIG. 21.

In the first position (release position), longitudinal axes u and w, which connect pivot axes b to c, and pivot axes c to m, define a (preferably obtuse) angle β. This may be, for example, approximately 95° to 130°, further, for example, approximately 100° to 115°.

Due to the application of force to toggle joint 65 by switching tappet 12, the angle is increased up to a value B′ of, for example, approximately 120° to 150°, further, for example, approximately 130° to 140°. In any case, an angle β′ is achieved that is smaller than 180°.

As a result of toggle lever arrangement 63 being provided, an increase in the contact pressure of locking jaw 35 acting on running surface 15 may be achieved with the same application of force via switching tappet 12, wherein this application of force is to be maintained in the second position of toggle lever arrangement 63, only under constant load via switching tappet 12 or via end effector E.

With the discontinuance of the load via switching tappet 12 by lifting the same, and due to the non-extended position of toggle lever arrangement 63 in the engagement position, toggle lever arrangement 63 with locking jaw 35, supported by second return spring 37 correspondingly acting on the second lever part 64, automatically moves back into the release position.

FIG. 31 shows a third embodiment, in which a toggle lever arrangement 63 according to the second embodiment shown in FIGS. 18 to 30 is combined with a quasi-float-mounted locking jaw 35 according to the first embodiment in FIGS. 1 to 17.

Locking element 34 is thereby substantially designed in two parts, on the one hand as a molded part, which float mounts locking jaw 35 according to the first embodiment and has holding openings 46 with support surfaces 47 and, on the other hand as a first lever part 62 of toggle joint arrangement 63.

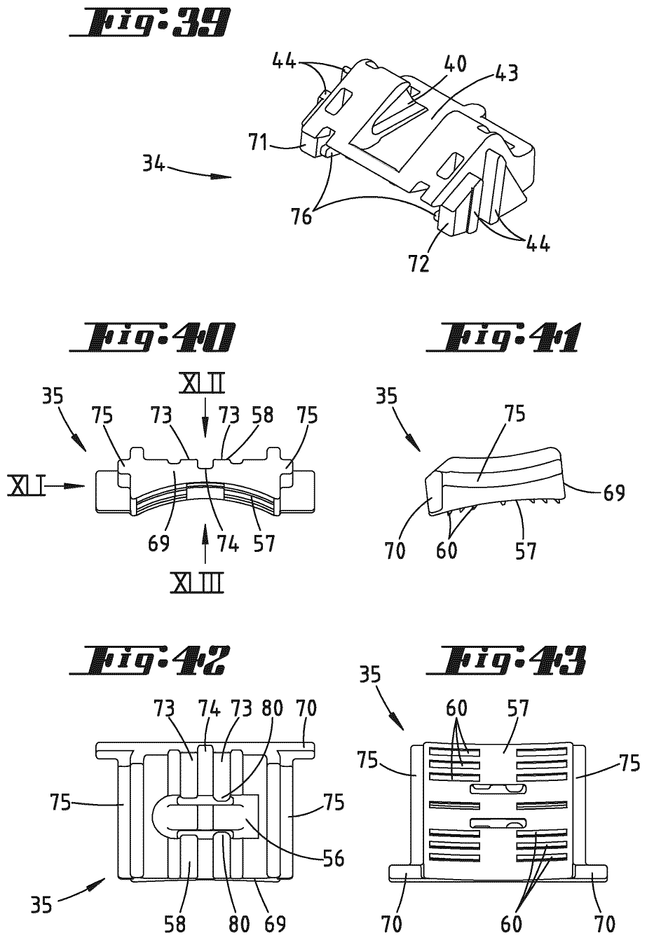

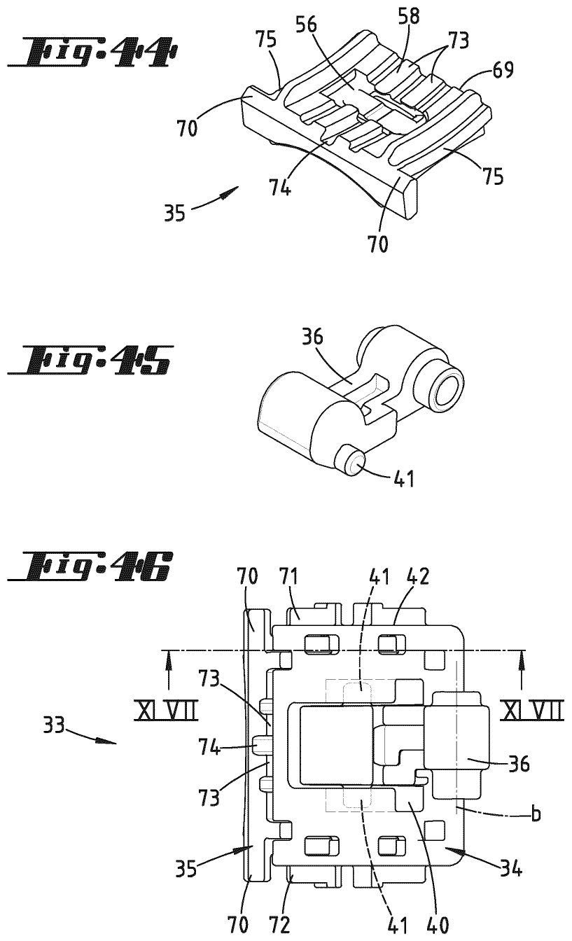

A fourth embodiment relating to locking element 34 and locking jaw 35 is shown and described with reference to FIGS. 32 to 48.

With reference to FIG. 32, it may initially be recognized that locking element 34 indeed has a holding opening 46 in a manner comparable to the locking element of FIGS. 1 to 17; however, this holding opening 46 is limited in one direction, in the depicted embodiment in the rear direction, by a blocking section 68 formed on locking element 34. Locking jaw 35 may come into contact with an end surface 69 during corresponding displacement in this direction. This displacement may be achieved in particular by the spring loading of locking jaw 35 in the lifted non-engaged state, which will be explained below. For this purpose, locking jaw 35 alternatively or additionally also has, in this context, a front-side overlap area 70, which, alternatively or additionally, may also function as stop areas 71 and 72 to limit the displacement relative to locking element 34.

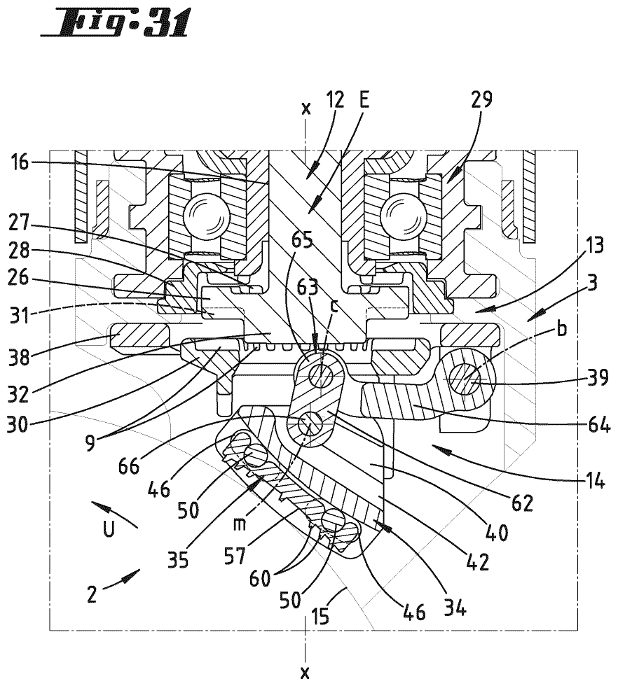

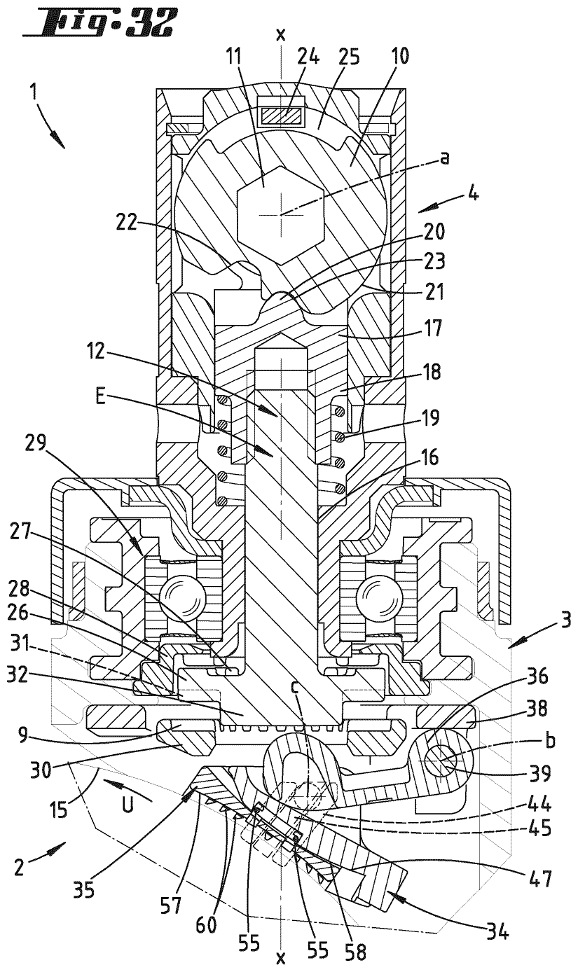

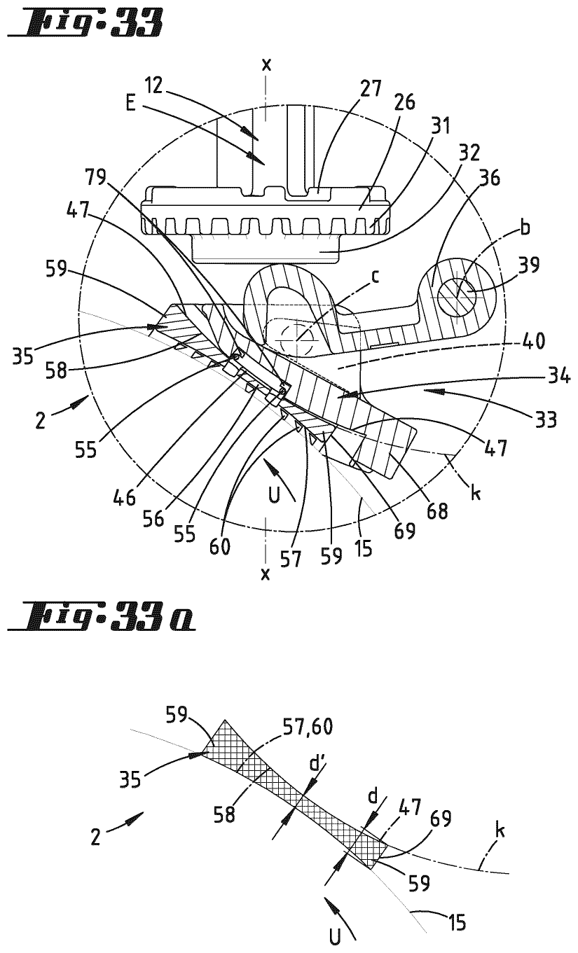

As arises, in particular from FIGS. 33 to 35, in the braking engagement state in any case, locking jaw 35 contacts an assigned support surface 47 on locking element 34 by means of, in the exemplary embodiment, preferably several, supporting surfaces 58, which are designed as elongated in a circumferential direction of running wheel 2.

Preferably several, namely, more preferably two supporting surfaces 58 aligned flush with one another, are realized in the exemplary embodiment. In addition, one or more supporting surfaces 58 are formed on one or more ribs 73 of locking jaw 35. One valley 74 or several valleys 74 are preferably formed between several ribs 73, which are provided transverse to circumferential direction U. The valley surface may function in the same way as supporting surface 58 in the case of a corresponding adaptation of support surface 47.

In the fourth exemplary embodiment, preferably in the transverse direction to circumferential direction U of running wheel 2, four supporting surfaces 58 are clearly provided as upper sides of ribs 73 and/or three supporting surfaces 58 are provided as upper sides of valleys 74 formed between the ribs 73.

This embodiment may also be viewed in further detail in FIGS. 42 and 44.

Furthermore, and in principle in accordance with the first embodiment of FIGS. 1 to 17, a spring 53 is accommodated in locking jaw 35. Spring 53 functions in particular to shift locking jaw 35 back into a starting position according to FIG. 33. It may thus correspondingly function for a displacement both forward and backward with respect to circumferential direction U of running wheel 2.

Spring 53 is also preferably formed as a U-shaped spring in the exemplary embodiment of FIGS. 32 to 42. It is further preferably held in place in locking jaw 35 in a latching way. For this purpose, one or more latching overlapping sections 80 in locking jaw 35 may be designed to interact with spring legs 55.

During a displacement of locking jaw 35 from the starting position, spring legs 55 may contact projections 79 formed on locking element 34, by means of which the spring force required for the automatic return is built up (comp. also FIGS. 33, 34, and 35).

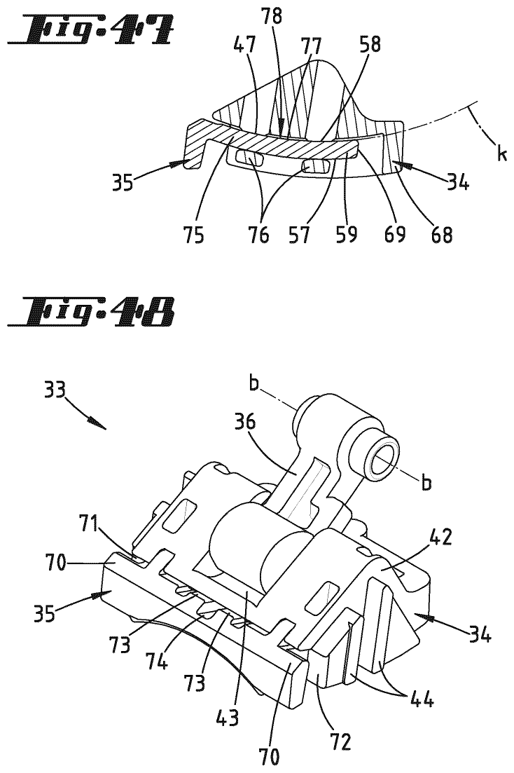

Locking jaw 35 further has two holding projections 75, preferably opposite one another, projecting transversely to their extension in the circumferential direction of running wheel 2. These are accommodated in adapted longitudinal guides 78 of locking element 34. As results, for example, from FIG. 47, locking element 34 has projection cams 76, which, in interaction with one or more counter cams 77, provide a bracket and longitudinal guide 78.

Regarding locking jaw 35 in this embodiment, a double wedge-shaped cross section also results with supporting surfaces 58 aligned adapted to line of curvature k running opposite to running surface 15 of running wheel 2. Jaw surface 57 thereby preferably runs adapted to the curvature of running surface 15. Correspondingly, a thickness d′ between the line of curvature k and the curvature of jaw surface 57 or sawtooth-like projections 60 which also define jaw surface 57 here approximately in the middle of a locking jaw 35 in circumferential direction U, which thickness d′ may correspond to approximately 0.5 to 0.8 times, possibly up to 0.95 times, edge thickness d (see FIG. 41).

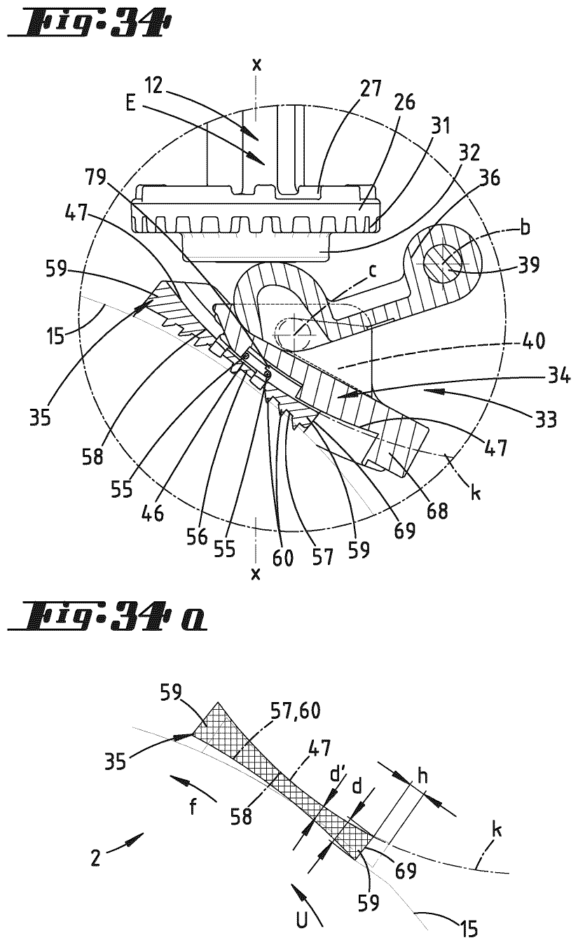

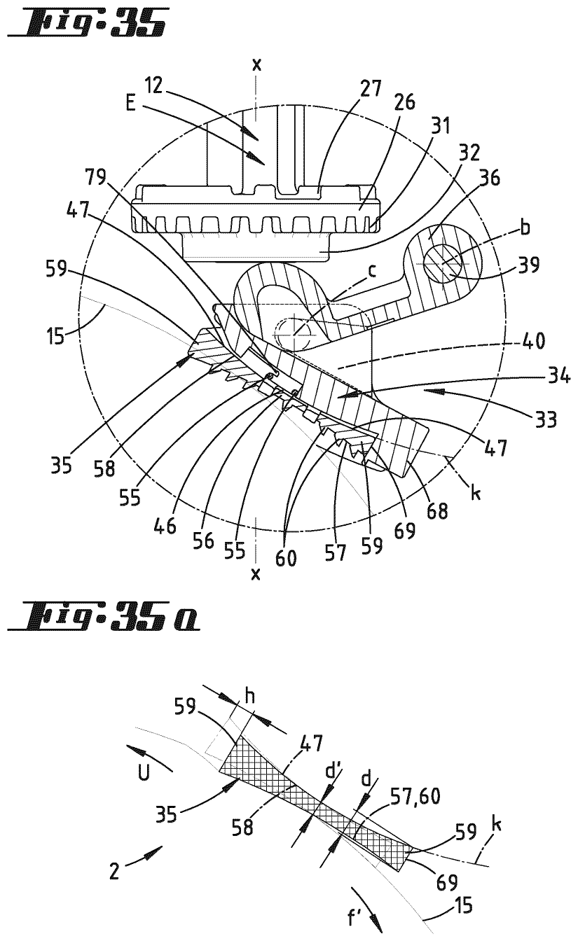

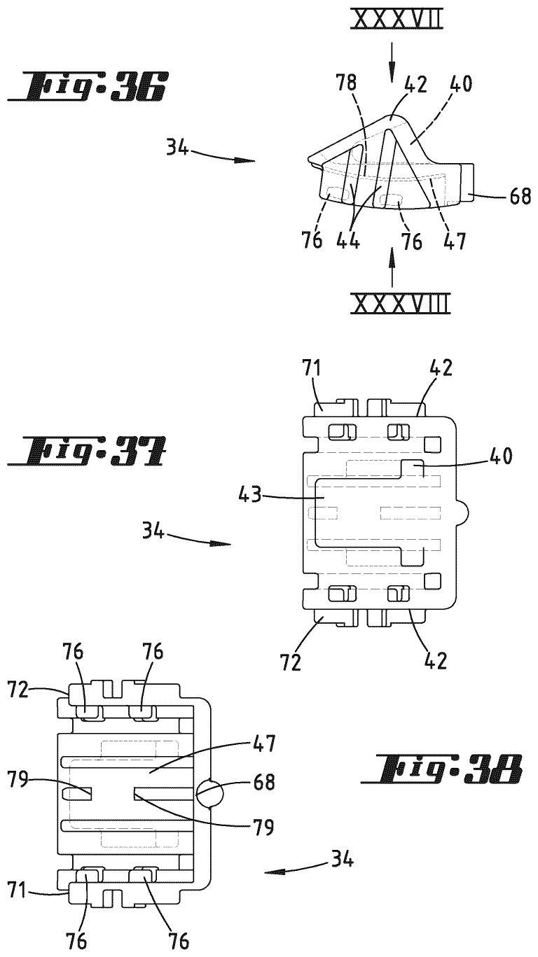

FIGS. 35 and 36 or the schematic depictions in FIGS. 35a and 36a show the two (maximum) possible final blocking positions of locking jaw 35 with respect to the fourth embodiment at a load f acting in circumferential direction U (counterclockwise with respect to the depiction in FIG. 35 or 35a), and at a load f′ (clockwise with respect to the depiction in FIG. 36 or 36a). There also results here an entrainment of locking jaw 35 in the same direction of the load due to the frictional engagement, with a corresponding guiding of locking jaw 35 in longitudinal guides 78 of locking element 34.

Locking element 34 has, comparable to the embodiment of FIGS. 1 to 17, a core section 43 into which lever part 36 engages. However, in this embodiment, lever part 36 is assigned to locking element 34 and is configured to be U-shaped in a central cross section transverse to pivot axis c, with a U-shaped opening that opens downwards.

Axle journals 41, previously described in the first embodiment, are provided on the outside of this U-shape, preferably directly molded thereon. Axle journals 41 engage in slot receptacles 40 of locking element 34.

In contrast to the first described embodiments of locking element 34 and locking jaw 35, independently moving parts are no longer provided on locking jaw 35. Locking jaw 35 is integrally formed, with the exception of the spring 53, which is preferably made of metal. It may be thus advantageously be provided as a single plastic injection-molded part, which is accommodated to be slidingly displaceable in locking element 34. A captive mounting on locking element 34 may thereby also be provided via the spring 53.

Furthermore, matching, in any case functionally matching, parts of this embodiment are provided with the same reference numerals as in the first described embodiments. In this respect, reference may also be made to the previous description for these parts.

The above statements function to explain the inventions covered by the application as a whole, which also independently refine the prior art, at least through the following combinations of features, whereby two, more or all of these combinations of features may also be combined, namely:

A caster, which is characterized in that support surface 47 is designed to be elongated in a circumferential direction U of running wheel 2, and that supporting surface 58 is movable along support surface 47 in circumferential direction U during a movement out of the initial blocking position into the final blocking position, so that supporting surface 58 as a whole is offset in circumferential direction U in the final blocking position with respect to support surface 47 and with respect to its position in the initial blocking position.

A caster, which is characterized in that locking element 34 has a holding opening 46, which is elongated in circumferential direction U of running wheel 2, for locking jaw 35.

A caster, which is characterized in that locking jaw 35 is designed to be double wedge-shaped in cross section, with a greatest thickness d at the respective end areas opposite one another in circumferential direction U of running wheel 2.

A caster, characterized in that locking jaw 35 has a reinforcing part 50 which interacts with support surface 47.

A caster, which is characterized in that reinforcing part 50 comprises a material that is different from the material of locking jaw 35.

A caster, which is characterized in that the reinforcing part 50 is designed as rod-shaped.

A caster, which is characterized in that locking jaw 35 is held on locking element 34 by means of the reinforcing part 50.

A caster, which is characterized in that two reinforcing parts 50 are provided spaced apart from one another in circumferential direction U of running wheel 2.

A caster, which is characterized in that supporting surface 58 is designed to be elongated in a circumferential direction U of running wheel 2.

A caster, which is characterized in that supporting surface 58 is formed by an upper side of one or more ribs 73 and/or an upper side of valleys 74 formed between ribs 73.

A caster, which is characterized in that locking jaw 35 has a retaining projection 75 which is cantilevered transversely to its extension in circumferential direction U of running wheel 2.

A caster, which is characterized in that holding projection 75 is elongated in circumferential direction U of running wheel 2.

A caster, which is characterized in that holding projection 75 is composed of several individual projections.

A caster, which is characterized in that the second position may only be maintained under constant application of force from end effector E.

A caster, which is characterized in that the lever parts 62 and 64 each have a longitudinal axis u and m and that, in the second position, longitudinal axes u and m together define an angle β′ of less than 180°.

A caster, which is characterized in that end effector E acts on toggle lever arrangement 63 in the area of toggle joint 65.

A caster, which is characterized in that end effector E is designed as a separate element from toggle lever arrangement 63.

A caster, which is characterized in that end effector E is movable between a contact position and a distanced position with respect to toggle lever arrangement 63.

A caster, which is characterized in that end effector E is designed as a linearly movable tappet.

A caster, which is characterized in that the tappet is designed as a switching tappet 12, which also allows for a pivotal blocking of caster 1.

All features disclosed are essential to the invention (in themselves, but also in combination with one another). The disclosure content of the associated/attached priority documents (copy of the prior application) is hereby fully included in the disclosure of the application, also for the purpose of including features of these documents in the claims of the present application. The subclaims, even without the features of a referenced claim, characterize with their features independent refinements of the prior art according to the invention, in particular in order to make divisional applications on the basis of these claims. The invention specified in each claim may additionally have one or more of the features provided in the preceding description, in particular provided with reference numerals and/or provided in the list of reference numerals. The invention also relates to configurations in which individual features of the features mentioned in the previous description are not implemented, in particular provided that they are clearly unnecessary for the respective intended use or may be replaced by other technically equivalent means.

List of Reference Numerals

| | |
|---|---|
| 1 | Caster |
| 2 | Running wheel |
| 3 | Fork |
| 4 | Mounting pin |
| 5 | Fork shell part |
| 6 | Fork shell part |
| 7 | Fork leg |
| 8 | Fork cavity |
| 9 | Blocking receptacle |
| 10 | Switching cam |
| 11 | Coupling opening |
| 12 | Switching tappet |
| 13 | Pivot locking device |
| 14 | Running wheel locking device |
| 15 | Running surface |
| 16 | Passage |
| 17 | Cam part |
| 18 | Annular collar |
| 19 | First return spring |
| 20 | Counter-cam |
| 21 | Control surface |
| 22 | Control recess |
| 23 | Control recess |
| 24 | Stop projection |
| 25 | Circumferential groove |
| 26 | Locking plate |
| 27 | Locking formation |
| 28 | Direction locking part |
| 29 | Bearing |
| 30 | Rotation blocking part |
| 31 | Rotation blocking projection |
| 32 | Extension |
| 33 | Locking assembly |
| 34 | Locking element |
| 35 | Locking jaw |
| 36 | Lever part |
| 37 | Second return spring |
| 38 | Holding part |
| 39 | Axle |
| 40 | Slot receptacle |
| 41 | Axle journal |
| 42 | Side wall |
| 43 | Core section |
| 44 | Guide rib |
| 45 | Counter rib |
| 46 | Holding opening |
| 47 | Support surface |
| 48 | Limiting surface |
| 49 | Under side |
| 50 | Reinforcing part |
| 51 | Side flank |
| 52 | Penetration |
| 53 | Spring |
| 54 | Slot opening |
| 55 | Spring leg |
| 56 | Receiving pocket |
| 57 | Jaw surface |
| 58 | Supporting surface |
| 59 | End area |
| 60 | Projection |
| 61 | Upper side |
| 62 | First lever part |
| 63 | Toggle lever arrangement |
| 64 | Second lever part |
| 65 | Toggle joint |
| 66 | Axle |
| 67 | Receptacle |
| 68 | Blocking section |
| 69 | Inner surface |
| 70 | Overlap area |
| 71 | Stop area |
| 72 | Stop area |
| 73 | Rib |
| 74 | Valley |
| 75 | Holding projection |
| 76 | Projection cam |
| 77 | Counter-cam |
| 78 | Longitudinal guide |
| 79 | Projection |
| 80 | Latching overlapping sections |
| a | Actuating axis |
| b | Pivot axis |
| c | Pivot axis |
| d | Thickness |
| d′ | Thickness |
| f | Load |
| f′ | Load |
| g | Length |
| h | Degree of displacement |
| k | Line of curvature |
| m | Pivot axis |
| r | Direction of movement |
| u | Longitudinal axis |
| w | Longitudinal axis |
| x | Pivot axis |
| y | Axis of rotation |
| E | End effector |
| U | Circumferential direction |
| α | Angle |
| β | Angle |
| β′ | Angle |

1. A caster (1) comprising;
a running wheel (2) having an axis of rotation (y) and a running surface (15), and a locking element (34) with a locking jaw (35), the locking element (34) being movable between a release position and an engagement position in which the locking jaw acts on the running surface (15) to lock the running wheel (2),
wherein in the engagement position, the locking jaw (35), while supported on the locking element (34), is movable from an initial blocking position into a final blocking position due to a rotational movement of the running wheel (2) itself,
wherein the locking jaw (35) is designed wedge-shaped in a cross section in which the axis of rotation (y) is represented as a point, and the locking element (34) has a support surface (47) for the locking jaw (35) and the locking jaw (35) has a supporting surface (58) which interacts with the support surface (47),
wherein the support surface (47) is designed to be elongated in a circumferential direction (U) of the running wheel (2), and wherein the supporting surface (58) is movable along the support surface (47) in the circumferential direction (U) during a movement out of the initial blocking position into the final blocking position, so that the supporting surface (58) as a whole is offset in the circumferential direction (U) in the final blocking position with respect to the support surface (47) and with respect to a position of the supporting surface (58) in the initial blocking position.

2. The caster according to claim 1, wherein the locking element (34) has a holding opening (46), which is elongated in the circumferential direction (U) of the running wheel (2), the holding opening (36) being configured for holding the locking jaw (35) on the locking element (34).

3. The caster according to claim 1, wherein the locking jaw (35) is designed to be double wedge shape in cross section, with a greatest thickness (d) at respective end areas opposite one another in the circumferential direction (U) of the running wheel (2).

4. The caster according to claim 1, wherein the locking jaw (35) has a reinforcing part (50) which interacts with the support surface (47).

5. The caster according to claim 4, wherein the reinforcing part (50) comprises a material that is different from the material of the locking jaw (35).

6. The caster according to claim 4, wherein the reinforcing part (50) is rod-shaped.

7. The caster according to claim 4, wherein the locking jaw (35) is held on the locking element (34) by means of the reinforcing part (50).

8. The caster according to claim 4, wherein two reinforcing parts (50) are provided spaced apart from one another in the circumferential direction (U) of the running wheel (2).

9. The caster according to claim 1, wherein the supporting surface (58) is elongated in a circumferential direction (U) of the running wheel (2).

10. The caster according to claim 1, wherein the supporting surface (58) is formed by an upper side of one or more ribs (73).

11. The caster according to claim 10, wherein the supporting surface (58) is formed by one or more upper sides of valleys (74) formed between ribs (73).

12. The caster according to claim 1, wherein the locking jaw (35) has a holding projection (75) which is cantilevered transversely to an extension of the locking jaw in the circumferential direction (U) of the running wheel (2).

13. The caster according to claim 12, wherein the holding projection (75) is elongated in the circumferential direction (U) of the running wheel (2).

14. The caster according to claim 12, wherein the holding projection (75) is composed of several individual projections.

15. A caster (1) comprising:
a running wheel (2) having an axis of rotation (y) and a running surface (15), and a locking element (34) with a locking jaw (35), the locking element (34) being movable between a release position and an engagement position in which the locking jaw (35) engages on the running surface (15) to lock the running wheel (2), wherein the locking element (34) is designed as a first lever part (62) of a toggle lever arrangement (63) and is rotatably connected to a second lever part (64) of the toggle lever arrangement (63) in a toggle joint (65),
wherein an end effector (E) moves the locking jaw (35) into the engagement position by moving the toggle lever arrangement (63) out of a first, more strongly angled position into a second, less angled position, and wherein the second position may only be maintained under constant application of force by the end effector (E).

16. The caster according to claim 15, wherein the lever parts (62, 64) each have a longitudinal axis (u, m) and wherein, in the second position, the longitudinal axes (u, m) together define an angle (β′) of less than 180°.

17. The caster according to claim 15, wherein the end effector (E) acts on the toggle lever arrangement (63) in the area of the toggle joint (65).

18. The caster according to claim 15, wherein the end effector (E) is designed as a separate element from the toggle lever arrangement (63).

19. The caster according to claim 15, wherein the end effector (E) is movable between a contact position and a distanced position with respect to the toggle lever arrangement (63).

20. The caster according to claim 15, wherein the end effector (E) is designed as a linearly movable tappet.

21. The caster according to claim 20, wherein the tappet is designed as a switching tappet (12), which also allows for the pivotal blocking of the caster (1).
